(19) United States
(12) Patent Application Publication
(10) Pub. No.: US 2022/0219591 A1
(43) Pub. Date: Jul. 14, 2022

(54) Roll Off Truck

(71) Applicant: Hol-Mac Corporation, Bay Springs, MS (US)

(72) Inventors: Mark J. Jobin, Laurel, MS (US); Harold W. Montgomery, Bay Springs, MS (US)

(21) Appl. No.: 17/571,060

(22) Filed: Jan. 7, 2022

Related U.S. Application Data
(60) Provisional application No. 63/135,399, filed on Jan. 8, 2021.

(51) Int. Cl. B60P 1/64; B60R 1/22; B60J 7/08

(52) U.S. Cl. CPC B60P 1/6454; B60J 7/085; B60R 1/22

(57) ABSTRACT

A new and improved roll-off truck is provided, consisting of a cab; a chassis; an integrated frame assembly connected to the chassis and is connectable to the gantry of a tarper system; a hoist comprising: a plurality of frame rails connected to the chassis at a pivot point at the rear of the chassis, and a plurality of hydraulic cylinders connected to the chassis and the plurality of frame rails, wherein the hoist is movable between a first position that is substantially horizontal and a second position that is angled to permit the loading and unloading of a container; and a control center mounted on the floor of the cab, comprising a swivel post that is adjustable to match the driver's preferred position and is configured to control the hoist and provide the displays for one or more external video cameras and the readout for an on-board scale.

### CROSS-REFERENCE TO RELATED APPLICATION

This application claims the benefit under 35 USC § 119(e) of U.S. Provisional Application No. 63/135,399 filed Jan. 8, 2021, which is incorporated by reference herein in its entirety.

### BACKGROUND OF THE INVENTION

The present invention relates generally to an improved roll-off hoist truck and method for loading and/or unloading a container onto a vehicle such as a truck used to transport the container. More particularly, the present invention relates to a roll-off hoist truck with an integrated design for accepting certain peripheral equipment without any additional modifications in the field.

Roll off trucks are commonly used to load, transport, and unload transportable containers. Such containers are typically large weldments having a capacity of 30-40 cubic yards, and are usually referred to as a roll-off container. As such, the weight of the container is relatively large even when empty, typically between 5000 and 6500 pounds. The vast majority of roll off containers in use today have standard understructure constructions designed to engage with a hoist for loading and unloading the container onto a roll off truck or trailer. Specifically, the hoist has a parallel rail configuration and a series of rollers at spaced locations along the rails, which are designed to engage with the recessed rails in the understructure of the container on the hoist.

To load a roll-off container onto the roll off truck, the truck is backed into a position squarely confronting the forward end of the container so that the rails of the container align with the rails on the hoist. The hoist is then swung about a pivot at the rear of the vehicle by operation of two hydraulic cylinders connected between the vehicle chassis and opposite sides of the hoist. The pivot is fixedly positioned on a rear frame portion of the vehicle to form a horizontal axis about which the hoist swings. The free end of a cable of a hydraulic reeving system on the hoist is drawn out so that a hook on the end portion can be connected to a hook on the container. The container is then advanced by the winch along a hoist until the center of gravity of the container is forward of the rear pivot, whereupon the hoist is swung downwardly onto the frame of the vehicle. The container is then pulled forwardly against front stops on the hoist.

When setting off a container or dumping material from the container, the hoist must be swung about the rear pivot to elevate the forward end of the container high above the vehicle. When dumping material from the container, the doors are opened before the container is elevated so that the material can slide out of the opening at the rear of the container when it is elevated. Sometimes a push-out blade is incorporated in the container to facilitate removal of material therefrom. When it is intended to set off a container from the vehicle, after the container is swung with the hoist about the rear pivot, the hydraulic reeving system is operated to feed out the cable and permit the container to slide along the hoist until the rear portion of the container engages the ground. Thereafter, the vehicle is slowly advanced while the forward end of the container slides along the rails of the hoist and into contact with the ground.

A number of peripheral equipment has been designed for roll off-trucks to enhance the above methods. For example, Pioneer Coverall, a division of Wastequip, LLC of N. Oxford, Mass., offers a number of tarper systems for covering and uncovering containers loaded on a roll off truck. As discussed hereinbelow, Pioneer tarper systems typically include a pair of hydraulically powered swing arms connected to a roller assembly, which is connected to either a stationary gantry or a hydraulically actuated elevating gantry. However, Pioneer tarper systems require custom installation (bolting and/or welding) depending on the specific chassis make (Mack, Peterbilt, Kenworth, Volvo, etc.) and truck configuration.

Another exemplary add-on for roll-off trucks is an onboard scale system, such as systems provided by Vulcan On-board Scales of Kent, Wash., to allow haulers to prevent overloaded hauls and more accurately understand their operational cost. As discussed hereinbelow, Vulcan scales require custom, precision-machined, mount ears for proper mounting to a specific chassis make. Importantly, any onboard scale system requires further custom installation including running cables from the scale systems' encoder to the truck cabin (typically a digital readout mounted into the dashboard).

These and other aftermarket equipment for roll-off trucks require custom installation. The present invention seeks to overcome the shortcomings associated with patchwork modifications and additions to roll-off trucks, providing a truly modular roll-off truck system that maximizes strength and utility.

### SUMMARY OF THE INVENTION

The present invention provides a new and improved design a roll-off truck consisting of a cab; a chassis; an integrated frame assembly connected to the chassis, wherein the integrated frame assembly is connectable to the gantry of a tarper system; a hoist comprising: a plurality of frame rails connected to the chassis at a pivot point at the rear of the chassis, and a plurality of hydraulic cylinders connected to the chassis and the plurality of frame rails, wherein the hoist is movable between a first position that is substantially horizontal and a second position that is angled to permit the loading and unloading of a container; and a control center mounted in the floor of the cab, comprising a swivel post that is adjustable to match the driver's preferred position. The roll-off truck further consists of one or more video cameras external to the truck, wherein the control center further comprises one or more displays for viewing the one or more video cameras. The roll-off truck further consists of an on-board scale, wherein the control center further comprises a digital readout for the scale and/or a printer for the scale. The control center is pre-wired to receive signals from a plurality of add-on peripherals selected from one or more video cameras and an onboard scale system. The gantry of the tarper system is either a stationary gantry or a hydraulically actuated elevating gantry. The roll-off truck further consists of a hydraulic tank connected to the integrated frame assembly, wherein the hydraulic tank provides pressurized hydraulic fluid to one or both of the plurality of hydraulic cylinders of the hoist and the hydraulically actuated tarper.

### BRIEF DESCRIPTION OF THE DRAWINGS

The features of the present invention will be more fully understood when the following description is read in light of the accompanying drawings, in which:

FIG. 1 is an illustrative embodiment of a roll-off truck modified to accept an onboard scale system in accordance with certain teachings of the present invention.

FIG. 2 is a magnified view of a portion of the illustrative embodiment of FIG. 1.

FIG. 3 is an illustrative embodiment of a roll-off truck modified to accept a tarper system in accordance with certain teachings of the present invention.

FIG. 4 is a magnified view of a portion of the illustrative embodiment of FIG. 3.

FIG. 5 is an exploded view of the illustrative embodiment of FIG. 3.

FIG. 6 is an illustrative embodiment of a roll-off truck modified to accept an integrated hydraulic tank in accordance with certain teachings of the present invention.

FIG. 7 is an exploded view of the illustrative embodiment of FIG. 6.

FIG. 8 is an illustrative embodiment of an ergonomically designed control center for a roll-off truck in accordance with certain teachings of the present invention.

FIG. 9 is an exploded view of the illustrative embodiment of FIG. 8.

### DESCRIPTION OF THE PREFERRED EMBODIMENT

The present invention provides a new and improved design and method for manufacturing a modular roll-off truck system capable of accepting desired peripheral equipment.

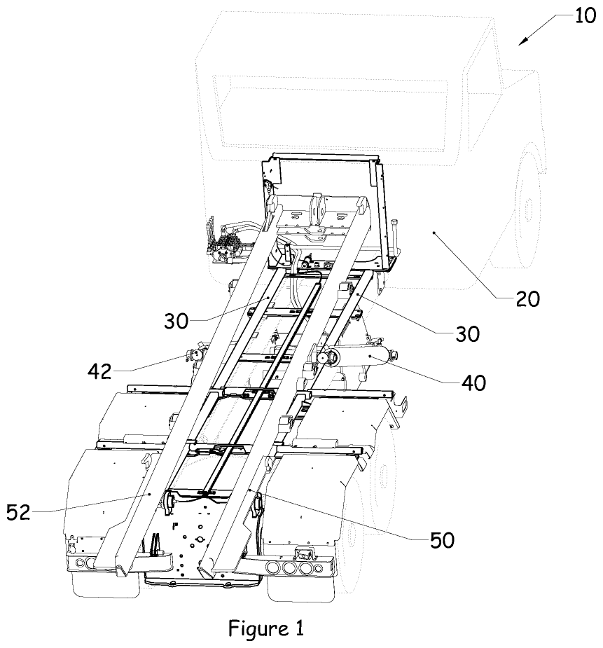

In a first embodiment of the present invention, a modular roll-off truck system for accepting an onboard scale system without any additional modifications in the field is provided. FIG. 1 illustrates this embodiment in the environment of a roll-off truck 10 having general components cab 20, sub-frame 30, hoist hydraulic cylinders 40/42, and upper frame rails 50/52.

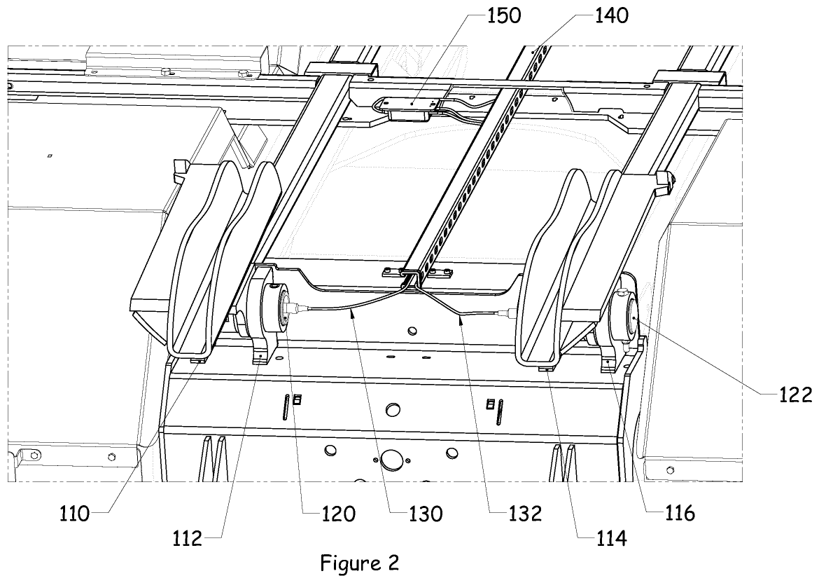

As shown in more detail in FIG. 2, four mount ears 110/112/114/116 are precision machined to accept two 3″ diameter shear pin load cells 120/122 for an onboard scale system, such as systems provided, for example, by Vulcan On-board Scales of Kent, Wash. Preferably, mount ears 110/112/114/116 are welded to the rear apron. Current industry standards for roll-off trucks do not include precision means for mounting, and it is understood that factory hinges are removed in the field when a customer desires to install an on-board scale system and replaced with a different set of weld-on hinges. The onboard scale system cables 130/132 are connected from the load cell pins 120/122 to an encoder 150 and from the encoder 150 to an in-cab control module by a formed channel 140. This novel design reduces the cost of scale system installation (no alteration or welding) and increases the feasibility of such systems, allowing haulers to prevent hauling overloaded hauls and more accurately understand their operational cost. Persons having ordinary skill in the art will appreciate that the size and configuration of mount ears can be altered in the manufacture of a modular roll-off truck system of the present invention, and that 3″ diameter shear pin load cells are but one current option available for roll-off applications.

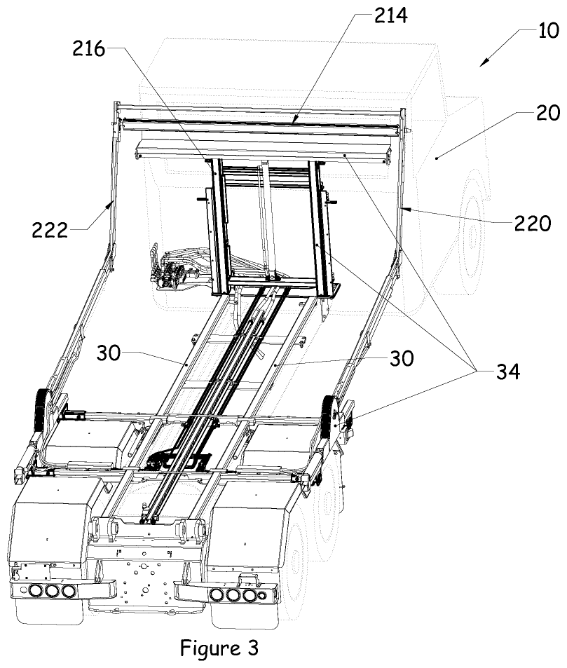

In a second embodiment of the present invention, a modular roll-off truck system for accepting a tarper system without any additional modifications in the field is provided. FIG. 3 illustrates this embodiment in the environment of a roll-off truck 10 having general components cab 20, sub-frame 30, and general tarper assembly 34. The illustrative general tarper assembly 34 shown in FIG. 3 is from Pioneer Coverall, a division of Wastequip, LLC of N. Oxford, Mass., which offers a number of tarper systems for covering and uncovering containers loaded on a roll off truck. A general tarper assembly 34 typically includes hydraulically powered swing arms 220/222 connected to a roller assembly 214, which is connected to either a stationary gantry (not shown) or a hydraulically actuated elevating gantry 216.

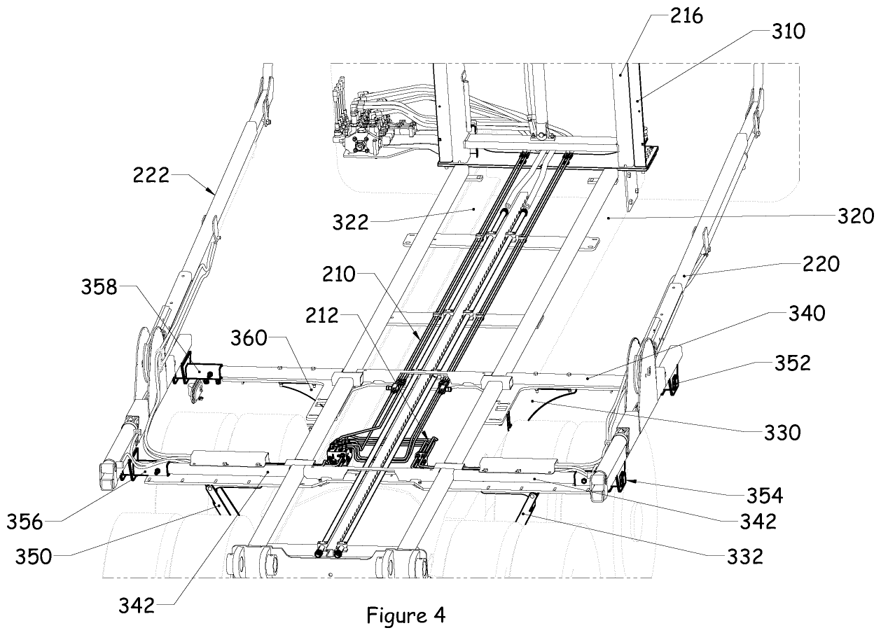

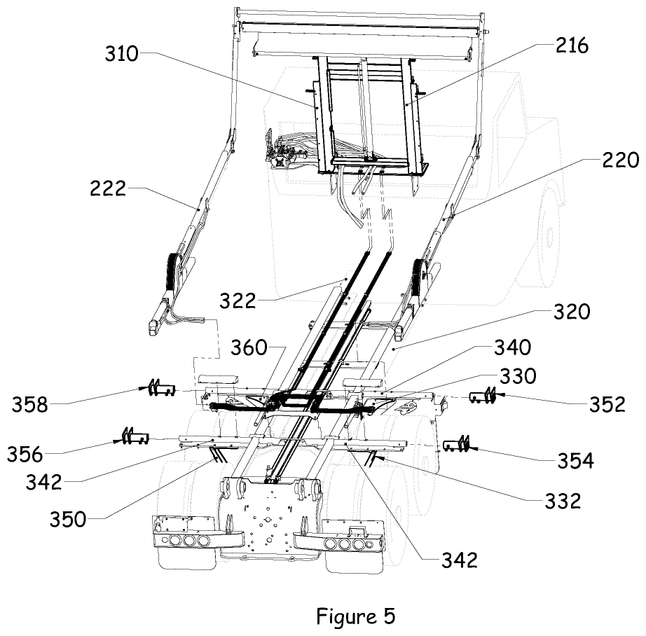

As shown in more detail in FIGS. 4 and 5, steel fluid lines 210/212 (as opposed to customary hydraulic hoses) contain pressurized hydraulic oil for moving tarper arms 220/222 between a first forward position (i.e., tarp fully rolled) and a second back position (i.e., tarp fully extended). Steel fluid lines are superior to hydraulic hoses because: (1) hydraulic hoses historically wear because of the routing through the chassis frame rails and cross members; (2) hydraulic hoses do not disperse heat as efficiently as the steel fluid lines; and (3) a cooler hydraulic system will provide hydraulic components a longer life cycle. Integrated frame assembly 310 is bolted directly to the chassis frames 320/322 of the truck, and creates a simple bolt-on design to gantry 216 of the tarper system. Gussets 330/340/350/360 are bolted directly to chassis frames 320/322, and are used to support mounting beams 340/342 of the sub frame. Tarper arms base brackets 352/354/356/358 bolt to mounting beams 340/342, providing a secure attachment to the tarper actuator for tarper arms 220/222. As such, the present invention provides a modular system that is fully bolted to the chassis without the need for welding to the fenders or tarper supports.

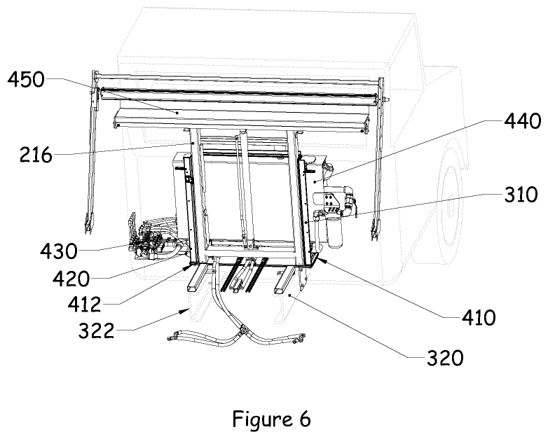

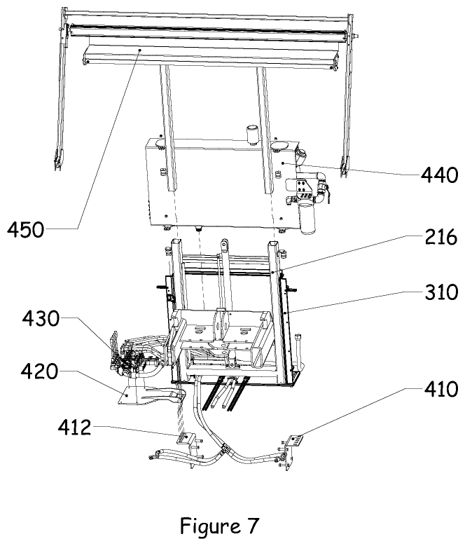

In a third embodiment of the present invention, a modular roll-off truck system for accepting a hydraulic tank without any additional modifications in the field is provided. FIGS. 6 and 7 illustrate the integrated frame assembly 310 (described above), which consists of two base mount brackets 410/412 that bolts integrated frame assembly 310 to the chassis frames 320/322. Valve mount bracket 420 bolts to integrated frame assembly 310, and is further bolted to hydraulic control valve 430. Hydraulic tank assembly 440 is then bolted to integrated frame assembly 310. Tarper rest assembly 450 rests inside integrated frame assembly 310. This bolt together integrated concept is designed for more flexible and efficient installation as opposed to the traditional weld together concept, and reduces the in-field installation time. A person of ordinary skill in the art will appreciate that additional holes in mounts, brackets and components allow for more flexibility in consideration of the many different chassis makes, models and configurations that historically have required custom modifications with a cutting torch and welding machine. A person of ordinary skill in the art will also appreciate, based on the above disclosure, that hydraulic tank 440 may provide pressurized hydraulic fluid to all hydraulic systems of the modular roll-off truck of the present invention, including without limitation, the tarper and the hoist (therefore replacing the standard hoist hydraulic tank).

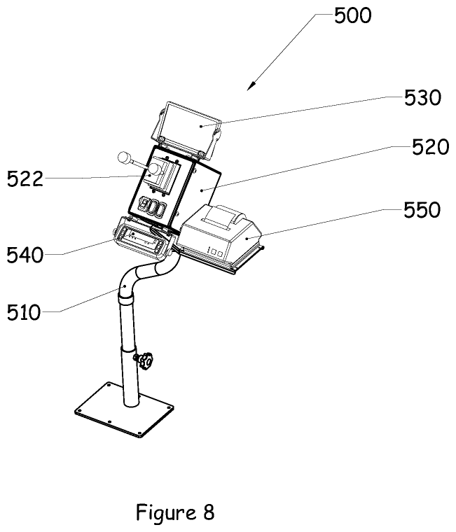

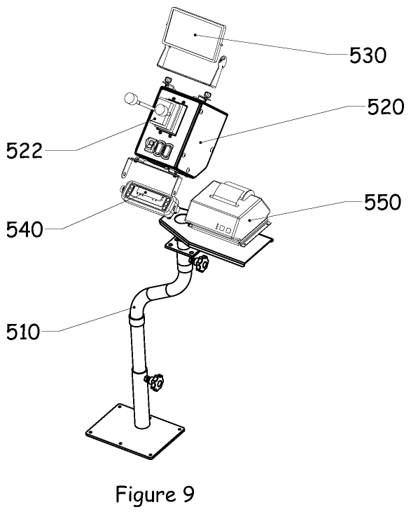

In a fourth embodiment of the present invention, a modular roll-off truck system comprising an ergonomically designed, in-cab, control center without any additional modifications in the field is provided. FIGS. 8 and 9 provides an illustrative example of one such control center 500, including a camera monitor, hoist controls, and a display and printer for an on-board scale system. The control center 500 of the present invention contains a swivel post 510 that is adjustable to match the driver's preference and is mounted in the floor of the cab in such a manner to allow more free space between the driver and passenger seats. Control box 520 encloses electrical switches and air valves, and comprises control joystick 522 for operating the hoist assemblies. Camera monitor 530 is electrically connected to one or more cameras located on the cab or chassis. Control center 500 also comprises a digital readout 540 for the on-board scale, as well as a printer 550 for the scale system. This novel ergonomic control center is designed to house all controls and is located at the fingertips and eye sight of the driver without looking in different places within the cab, as is historically the case (hoist and tarper controls in a box on the floor of the cab, scale readout on the dash, camera screens on the dash, etc.). Importantly, the control center 500 of the present invention also provides a uniform, modular, “plug-in-play” solution for wiring and cables associated with common add-on peripherals for roll-off trucks. A person having ordinary skill in the art will appreciate that any number and combination of peripheral assemblies can be utilized with the control center of the present invention, including other systems not specifically described above (multiple cameras, tarper controls, etc.), without deviating from the spirit and teachings of the presently disclosed invention.

In a fifth embodiment of the present invention, a roll-off truck consists of a cab; a chassis; an integrated frame assembly connected to the chassis, wherein the integrated frame assembly is connectable to the gantry of a tarper system; a hoist comprising: a plurality of frame rails connected to the chassis at a pivot point at the rear of the chassis, and a plurality of hydraulic cylinders connected to the chassis and the plurality of frame rails, wherein the hoist is movable between a first position that is substantially horizontal and a second position that is angled to permit the loading and unloading of a container; and a control center mounted on the floor of the cab, comprising a swivel post that is adjustable to match the driver's preferred position. The roll-off truck further consists of one or more video cameras external to the truck, wherein the control center further comprises one or more displays for viewing the one or more video cameras. The roll-off truck further consists of an on-board scale, wherein the control center further comprises a digital readout for the scale and/or a printer for the scale. The control center is pre-wired to receive signals from a plurality of add-on peripherals selected from one or more video cameras and an onboard scale system. The gantry of the tarper system is either a stationary gantry or a hydraulically actuated elevating gantry. The roll-off truck further consists of a hydraulic tank connected to the integrated frame assembly, wherein the hydraulic tank provides pressurized hydraulic fluid to one or both of the plurality of hydraulic cylinders of the hoist and the hydraulically actuated elevating gantry.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention.

What is claimed is:

1. A roll-off truck, comprising:
a cab;
a chassis;
an integrated frame assembly connected to the chassis, wherein the integrated frame assembly is connectable to the gantry of a tarper system;
a hoist comprising: a plurality of frame rails connected to the chassis at a pivot point at the rear of the chassis, and a plurality of hydraulic cylinders connected to the chassis and the plurality of frame rails, wherein the hoist is movable between a first position that is substantially horizontal and a second position that is angled to permit the loading and unloading of a container; and
a control center mounted on the floor of the cab, comprising a swivel post that is adjustable to match the driver's preferred position; and a control box for controlling the hoist and hoist hydraulic cylinders.

2. The roll-off truck of claim 1, wherein the truck further comprises one or more video cameras external to the truck, and wherein the control center further comprises one or more displays for viewing the one or more video cameras.

3. The roll-off truck of claim 1, wherein the truck further comprises an on-board scale, and wherein the control center further comprises a digital readout for the scale.

4. The roll-off truck of claim 3, wherein the control center further comprises a printer for the scale.

5. The roll-off truck of claim 1, wherein the control center is pre-wired to receive signals from a plurality of add-on peripherals.

6. The roll-off truck of claim 5, wherein the plurality of add-on peripherals is selected from one or more video cameras and an onboard scale system.

7. The roll-off-truck of claim 1, wherein the gantry is a stationary gantry.

8. The roll-off-truck of claim 1, wherein the gantry is a hydraulically actuated elevating gantry.

9. The roll-off truck of claim 1, further comprising a hydraulic tank connected to the integrated frame assembly, wherein the hydraulic tank provides pressurized hydraulic fluid to the plurality of hydraulic cylinders of the hoist.

10. The roll-off truck of claim 1, further comprising a hydraulic tank connected to the integrated frame assembly, wherein the hydraulic tank provides pressurized hydraulic fluid to the plurality of hydraulic cylinders of the hoist and the tarper system.
